(19) United States
(12) Patent Application Publication
(10) Pub. No.: US 2025/0189229 A1
(43) Pub. Date: Jun. 12, 2025

(54) DUAL COMPONENT WELDED ANCHOR SYSTEM

(71) Applicant: ExxonMobil Technology and Engineering Company, Spring, TX (US)

(72) Inventors: Christopher J. FOWLER, Houston, TX (US); Patrick L. YODER, Montgomery, TX (US)

(73) Assignee: ExxonMobil Technology and Engineering Company, Spring, TX (US)

(21) Appl. No.: 19/057,468

(22) Filed: Feb. 19, 2025

Related U.S. Application Data
(60) Provisional application No. 63/496,346, filed on Apr. 14, 2023.

(51) Int. Cl. F27D 1/10

(52) U.S. Cl. CPC F27D 1/10

(57) ABSTRACT

An anchor system includes an anchor head made of a non-metallic material and including a main body, a plurality of legs extending radially outward from the main body, and a stem extending from the main body. A stud base is made of a metallic material and defines a hole sized to receive the stem.

### FIELD OF INVENTION

This application relates to an anchor system for securing a refractory lining to a vessel wall. In particular, the presently disclosed subject matter relates to a corrosion-resistant anchor system for use in anchoring a monolith refractory liner.

### BACKGROUND

Refractory liners provide thermal insulation as well as abrasion and erosion resistance in process vessels, reactors, conduits, furnaces, regenerators, stacks, and fluidized catalytic reactors. As such, refractory liners may extend the lifetime of these vessels while enabling operations which involve elevated temperatures. While traditional monolithic refractory liners utilize hexmetal anchoring for the anchoring of the refractory lining, single component anchoring systems have been developed which replicate the shape and purpose of the hexmetal systems while being modular. The single component anchoring systems may include components which are individually installed in the hexagonal pattern of the traditional hexmetal, while the modular grid of individual components enables the expansion and retraction of the monolithic refractory lining during thermal shifting of the vessel.

The single component anchoring systems are traditionally formed from metallic components, such as carbon or alloy steel, which enable the welding of the high-durability material to the surface of the vessel wall. However, refractory monoliths utilized in refractory liners are porous in nature, which may expose the individual anchors to the contents of the vessel. In applications employing corrosive materials within the vessel, traditional metallic components may be exposed to these corrosive materials and may degrade. The degradation of the single component anchoring systems may expose the vessel to abrasion and erosion as well as reduce the thermal insulation provided to the vessel, while further requiring repair, replacement, and downtime for the vessel.

As such, a corrosion-resistant anchoring system which maintains the modularity of the single component anchoring system is desirable.

### SUMMARY OF INVENTION

The present disclosure includes an anchor system that comprises: an anchor head made of a non-metallic material and including: a main body; a plurality of legs extending radially outward from the main body; and a stem extending from the main body; and a stud base made of a metallic material and defining a hole sized to receive the stem.

The present disclosure also includes a method of mounting an anchor system to a vessel wall, the method comprising: locating a distal end of a stud base against the vessel wall, the stud base being made of a metallic material and defining a hole; welding the stud base to the vessel wall; and attaching an anchor head made of a non-metallic material to the stud base, the anchor head including a main body, and a plurality of legs extending radially outward from the main body.

The present disclosure further includes an anchor system that comprises: an anchor head made of a non-metallic material and including a main body that defines a central aperture, and a plurality of legs extending radially outward from the main body; a fastener comprising an enlarged head and a stem; and a stud base made of a metallic material and defining a hole sized to receive the stem of the fastener, wherein the anchor head is secured to the stud base by extending the stem through the central aperture and receiving the stem in the hole.

These and other features and attributes of the disclosed apparatuses and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a schematic side view of an example dual component welded anchor system, in accordance with the principles of the present disclosure.

FIGS. 2A and 2B are top views of example anchor heads with varying numbers of legs and varying geometry.

FIG. 3 is schematic side view of another example dual component welded anchor system, in accordance with the principles of the present disclosure.

FIGS. 4A and 4B are top views of example fasteners and anchor heads with varying numbers of legs and varying geometry.

FIGS. 5A and 5B are exploded side views of the dual component welded anchor systems of FIGS. 1 and 3, respectively, showing example installation.

### DETAILED DESCRIPTION

This application relates to an anchor system for securing a refractory lining to a vessel wall. In particular, the presently disclosed subject matter relates to a dual component, corrosion-resistant anchor system for use in anchoring a monolith refractory liner. The dual component welded anchor system disclosed herein may provide corrosion-resistance through a non-metallic anchor head while maintaining modularity and weld strength through a metallic stud base. The dual component welded anchor system may improve resistance to corrosion, erosion, electrical conduction, and thermal conduction compared to traditional anchoring systems.

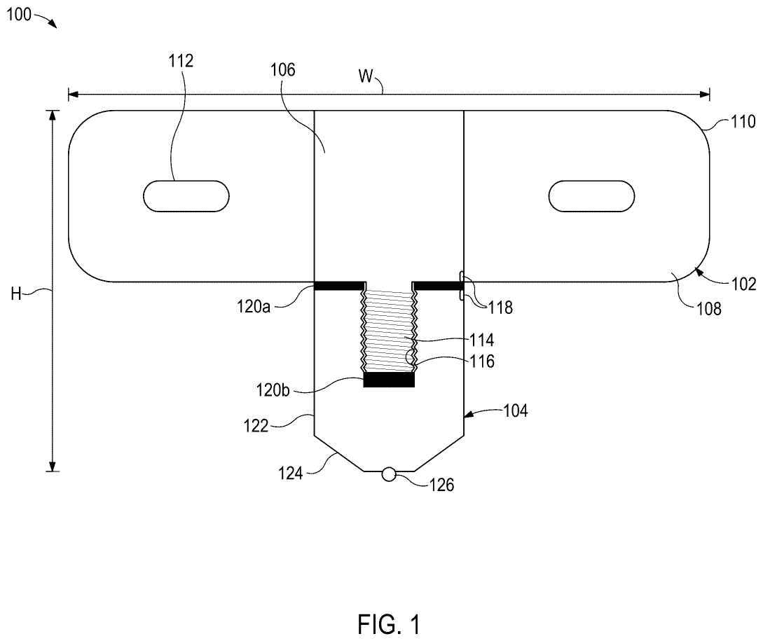

FIG. 1 is a schematic side view of an example dual component welded anchor system 100, according to one or more embodiments of the present disclosure. The dual component welded anchor system 100 (hereinafter “the system 100”) may be used to secure a refractory liner (not shown) to the wall of a refractory-lined vessel including, but not limited to, a process vessel, a reactor (e.g., a fluidized catalytic reactor), a conduit, a furnace, a regenerator, a stack, high corrosive chemical processing equipment, or any combination thereof. As illustrated, the system 100 may include an anchor head 102 which may anchor the refractory liner, and a stud base 104 which may facilitate attachment of the system 100 to the wall of a vessel.

The anchor head 102 may be formed of a non-metallic material such as, but not limited to, a ceramic (e.g., a metal oxide ceramic, a nitride ceramic, a carbide ceramic), neoprene, a silicone material, a polymer material, an epoxy, a concrete material, any combination thereof, and other corrosion-resistant materials. In at least one embodiment, a ceramic material may be utilized for the anchor head 102, since ceramics exhibit high resistance to both corrosion and erosion.

In contrast, the stud base 104 may be formed of one or more metallic materials, such as a carbon steel or an alloy steel. Consequently, the stud base 104 may be able to be welded to the wall of a vessel configured to be lined with a refractory material. In at least one embodiment, the stud base 104 may be formed of two or more metal materials, such as a carbon and alloy steel, which may improve the welding process as well as the mating process between the anchor head 102 and the stud base 104.

The dimensions of the system 100 may vary, depending on the application. In at least one embodiment, for example, the system 100 may exhibit a height H of about 0.5 to about 3 inches, and a width (or length) W of about 1 to about 3 inches. Those skilled in the art will readily appreciate, however, that the system 100 may be smaller or larger than these dimensions, without departing from the scope of this disclosure.

The anchor head 102 may comprise a main body 106 and a plurality of legs 108 extending radially outward from the main body 106 in a variety of directions. The main body 106 enables attachment of the anchor head 102 to the stud base 104. The plurality of legs 108 may extend from the main body 106 and help form a hexagonal pattern when combined with other adjacent systems, the hexagonal pattern being similar to that of the traditional hexmetal utilized in refractory liner anchoring.

In some embodiments, as illustrated, the legs 108 may include filleted or otherwise rounded edges and corners 110 such that no sharp features are present on the main body 106 or the legs 108. The lack of sharp features enables the use of ceramics for the anchor head 102 without the risk of such sharp features becoming stress risers which may enable the propagation of cracks throughout the anchor head 102.

The legs 108 may comprise plate-like structures extending radially outward from the main body 106. Moreover, one or more of the legs 108 may further include or otherwise define one or more apertures 112, which may enable the flow of material through the anchor head 102 during installation of the refractory material. In some embodiments, as illustrated, one or more of the apertures 112 may exhibit an elongated, pill shape, but could alternatively exhibit other shapes including, but not limited to, round, oval, ovoid, polygonal, or any combination thereof. The flow of material through the apertures 112 may enable the refractory lining to be present both around and through the anchor head 102.

The anchor head 102 may further include a stem 114 that extends from the main body 106. In at least one embodiment, the stem 114 extends from the main body 106 orthogonal to the direction that the legs 108 extend from the main body 106. The stem 114 may be configured to be received within a hole 116 centrally defined in the stud base 104. As illustrated, the stem 114 and the hole 116 may each define threading that allows the stem 114 to be threaded into the hole 116. Accordingly, in the illustrated embodiment, the stem 114 may comprise a male component part configured to mate with the hole 116, which constitutes a female component part. Those skilled in the art will readily appreciate, however, that the stem 114 may alternatively be defined by the stud base 104, while the hole 116 may be defined by the anchor head 102, without departing from the scope of this disclosure.

During the fastening of the anchor head 102 to the stud base 104 via the stem 114 and the hole 116, one or more alignment indicators 118 may be utilized to ensure proper installation and positioning of the anchor head 102 relative to the stud base 104. The alignment indicators 118 may comprise indentions, raised features, stickers, markings, or any other visible sign that the stem 114 has been properly received within the hole 116. In at least one embodiment, the stem 114 and the hole 116 may include a lock-in thread, a crimp, or another type of mechanism configured to help prevent the anchor head 102 from unthreading from the stud base 104.

The system 100 may further include one or more body gaskets 120a arranged to interpose opposing portions of the anchor head 102 and the stud base 104. The body gasket 120a may be configured to provide an offset or gap between the anchor head 102 and the stud base 104 and thereby able to account for thermal expansions differences between the metallic material of the stud base 104 and the non-metallic material of the anchor head 102. Moreover, in some embodiments, the system 100 may further include a stud gasket 120b arranged at the bottom of the hole 116 and generally interposing the end of the stem 114 and the bottom of the hole 116. The stud gasket 120b may similarly account for thermal expansions differences between the opposing metallic and non-metallic materials of the stud base 104 and the anchor head 102.

In some applications, the gaskets 120a,b may also help reduce the overall thermal conductivity through the system 100. Example materials for one or both of the gaskets 120a,b include, but are not limited to, ceramic fiber, graphite foil, or any combination thereof. In at least one embodiment, one or both gaskets may exhibit a thickness of about one millimeter.

The stud base 104 may further include a metallic body 122 which may be attached (e.g., stud welded) to a vessel configured to receive a refractory liner. To this end, the metallic body 122 may include a beveled edge or shoulder 124, which reduces the diameter of the metallic body 122 near the bottom of the stud base 104. In some embodiments, a flux ball 126 may be included at the distal end of the stud base 104, and the flux ball 126 may be configured to help facilitate the stud welding process and scavenge oxygen from the surroundings during drawn arc welding processes.

For stud welding installation, a ceramic ferrule (not shown) may be used to surround the stud base 104 and thereby help improve the weld quality. Those skilled in the art will readily appreciate that further means of attachment, such as stick welding, may be utilized in the installation of the system 100 without departing from the scope of this disclosure.

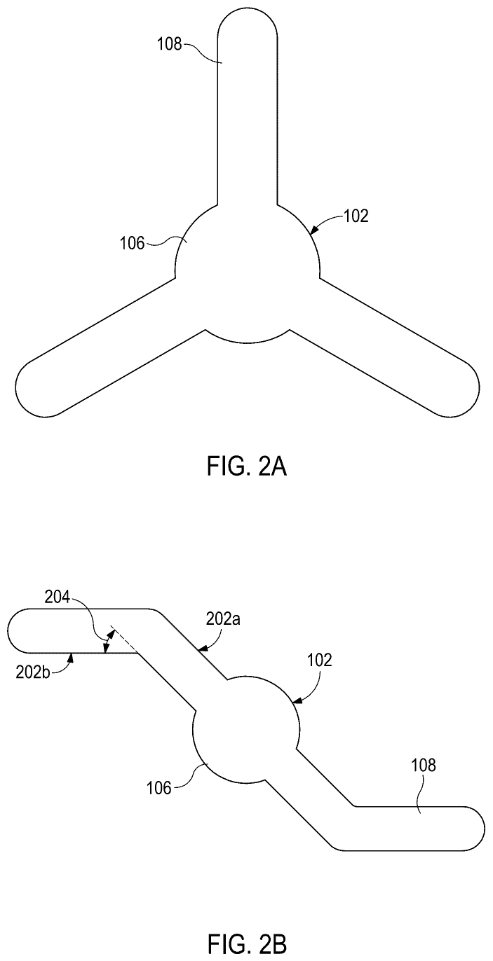

FIGS. 2A and 2B are top views of example anchor heads 102 with varying numbers of legs 108 and varying geometry, according to one or more embodiments of the present disclosure. FIG. 2A depicts an example anchor head 102 which includes three legs 108 extending radially outward from the main body 106. In the illustrated embodiment, the legs 108 are equidistantly spaced from each other, and are thus angularly separated from each other by 120°. This allows the legs 108 to cooperatively enable or define a hexagonal design when installed adjacent other similar anchor heads, such that each leg 108 acts as a side of the hexagon.

FIG. 2B depicts an example anchor head 102 which includes two legs 108 extending radially outward from the main body 106 on angularly opposite sides of the main body 106. In contrast to the embodiment of FIG. 2A, each leg 108 acts as two or more sides of the hexagonal design when installed adjacent other anchor heads 102. More specifically, in the illustrated embodiment, each leg 108 includes or otherwise defines a first extension 202a extending from the main body 106, and a second extension 202b extending from the first extension 202a. As illustrated, the second extension 202b extends from the first extension at an angle 204. The angle 204 may be, for example, about 30°, but could be greater or less than 30°, without departing from the scope of the disclosure. When the anchor head 102 is installed adjacent other similar anchor heads, the first and second extensions 202a,b of each leg 108 may serve as two sides of a hexagon.

Those skilled in the art will readily appreciate that more than three legs 108 may be utilized in the design of the anchor heads 102 without departing from the scope of this disclosure. Regardless of the number of legs 108, FIGS. 2A and 2B depict anchor heads 102 which may be installed to mimic the hexmetal design of traditional refractory liner anchor systems.

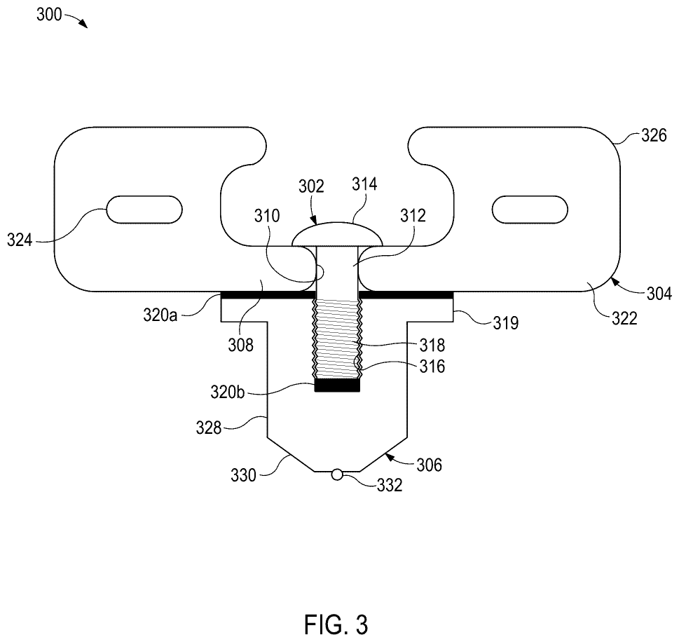

FIG. 3 is schematic side view of another example dual component welded anchor system 300, according to at least one embodiment of the present disclosure. The alternate dual component welded anchor system 300 (hereinafter “the system 300”) may share similarities with the system 100 of FIG. 1, however the components of the system 300 may be coupled using a mechanical fastener 302, which is not present in the system 100. Similar to the system 100 of FIG. 1, the system 300 may include a non-metallic anchor head 304 and a metallic stud base 306. Unlike the system 100, however, the fastener 302 extends through and fastens the two components together.

The fastener 302 may be made of a variety of rigid or semi-rigid materials. In some embodiments, the fastener 302 may be made of a metal, which may be the same as the metal material of the stud base 306. In other embodiments, however, the fastener 302 may be made of a non-metallic material, similar to the material of the anchor head 304.

The anchor head 304 may further include a main body 308 and a plurality of legs 322 extending radially outward from the main body 308. In the illustrated embodiment, the main body 308 may comprise a ring-like structure that defines a central aperture 310 through which a portion of the fastener 302 (e.g., a stem 312) may extend to attach the anchor head 304 to the stud base 306. The fastener 302 may further include an enlarged head 314 from which the stem 312 extends. The central aperture 310 may exhibit a larger diameter than the stem 312, but a smaller diameter than the head 314.

As illustrated, the stem 312 may be configured to be received within a hole 316 defined in the stud base 306 in a male-female mated relationship. In at least one embodiment, a portion of the stem 312 may be threaded 318 and configured to be threadably received within the hole 316. Securing the fastener 302 to the stud base 306 may couple the anchor head 304 to the stud base 306 through friction between the head 314 of the fastener 302 and the central aperture 310 of the anchor head 304.

In at least one embodiment, the stud base 306 may further include or provide a radial shoulder 319 which extends radially outward from an upper section of the stud base 306. The radial shoulder 319 may provide a larger surface area for contact between the anchor head 304 and the stud base 306 when coupled via the fastener 302. Moreover, similar to the system 100 of FIG. 1, the system 300 may further include one or more body gaskets 320a arranged to interpose opposing portions of the anchor head 304 and the stud base 306. The body gasket 320a may be configured to provide an offset or gap between the anchor head 304 (e.g., the radial should 319) and the stud base 306 to account for thermal expansions differences between the metallic material of the stud base 306 and the non-metallic material of the anchor head 304. Moreover, in some embodiments, the system 300 may further include a stud gasket 320b arranged at the bottom of the hole 316 and generally interposing the end of the stem 312 and the bottom of the hole 316. The stud gasket 320b may similarly account for thermal expansions differences between the opposing metallic and non-metallic materials of the stud base 306 and the anchor head 304. The gaskets 320a,b may also help reduce the overall thermal conductivity of the system 300.

The legs 322 may comprise plate-like structures that include one or more apertures 324 which enable material flow through the legs 322. Similar to the apertures 112 of FIG. 1, one or more of the apertures 324 may exhibit an elongated, pill shape, but could alternatively exhibit other shapes including, but not limited to, round, oval, ovoid, polygonal, or any combination thereof. Moreover, the legs 322, and the anchor head 304 as a whole, may be designed with rounded edges and corners 326 to reduce the presence of stress risers within the anchor head 304.

In some embodiments, the stud base 306 may include a body 328 that provides a beveled or tapered edge or shoulder 330 at its distal end. In some embodiments, a flux ball 332 may be included at the distal end of the stud base 306, and the flux ball 332 may be configured to help facilitate the stud welding process. The shoulder 330, along with the flux ball 332, may be included to aid in the stud welding process that may be used in the installation of the stud base 306 to a vessel (not shown) configured to be lined with a refractory material.

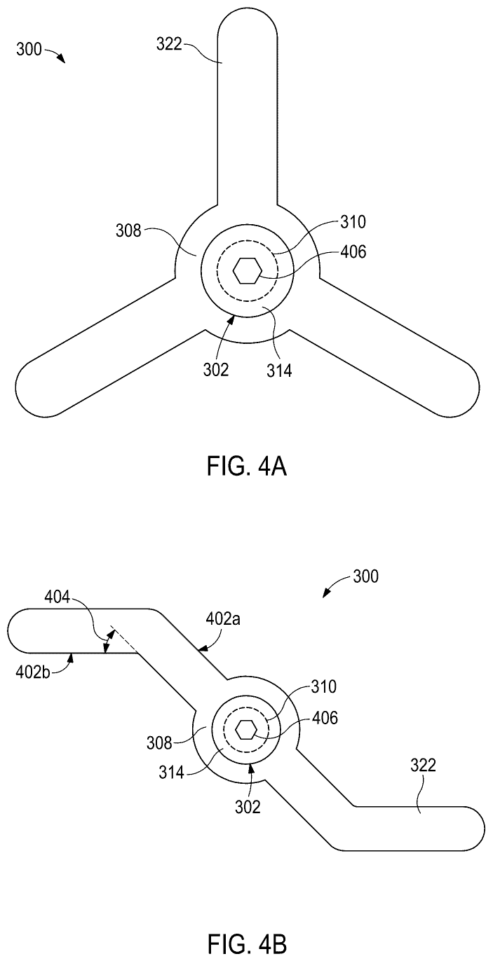

FIGS. 4A and 4B are top views of example embodiments of the system 300 of FIG. 3, according to one or more embodiments of the present disclosure. More specifically, FIGS. 4A-4B depict the fastener 302 and the anchor head 304 with varying numbers of legs 322 and varying geometry.

The anchor head 304 in FIG. 4A includes three legs 322 extending radially outward from the main body 308. In the illustrated embodiment, the legs 322 are equidistantly spaced from each other, and are thus angularly separated from each other by 120°. This allows the legs 322 to cooperatively enable a hexagonal design when installed adjacent similar anchor heads, such that each leg 322 acts as a side of the hexagon.

The anchor head 304 in FIG. 4B includes two legs 322 extending radially outward from the main body 308 on angularly opposite sides of the main body 308. In contrast to the embodiment of FIG. 4A, each leg 322 act as two or more sides of the hexagonal design when installed adjacent additional anchor heads 304, with the illustrated embodiment showing each leg 322 acting as two sides of a hexagon. More specifically, in the illustrated embodiment, each leg 322 includes or otherwise defines a first extension 402a extending from the main body 308, and a second extension 402b extending from the first extension 402a. As illustrated, the second extension 402b extends from the first extension at an angle 404. The angle 404 may be, for example, about 30°, but could be greater or less than 30°, without departing from the scope of the disclosure. When the anchor head 304 is installed adjacent other similar anchor heads, the first and second extensions 402a,b may act as two sides of a hexagon.

Those skilled in the art will readily appreciate that more than three legs 322 may be utilized in the design of the anchor heads 304 without departing from the scope of this disclosure. Regardless of the number of legs 322, FIGS. 4A and 4B depict anchor heads 304 which may be installed to mimic the hexmetal design of traditional refractory liner anchor systems.

In both FIGS. 4A-4B, the fastener 302 is depicted as received within the central aperture 310. In some embodiments, the fastener 302 may include and otherwise define a fastening feature 406 configured to help secure the fastener 302 within the central aperture 310. In the illustrated embodiment, the fastening feature 406 comprises an aperture defined in the top of the head 314, such as a hexagonal hole or slot capable of receiving a tool head configured to provide torque to the head 314. In other embodiments, however, the fastening feature 406 may comprise a shaped feature provided about the outer circumference of the head 314, where a tool (e.g., a wrench) may impart torque to the fastener 302. As will be appreciated, the fastening feature 406 may vary in shape and size from the fastening feature 406 shown in FIGS. 4A 4B, without departing from the scope of this disclosure.

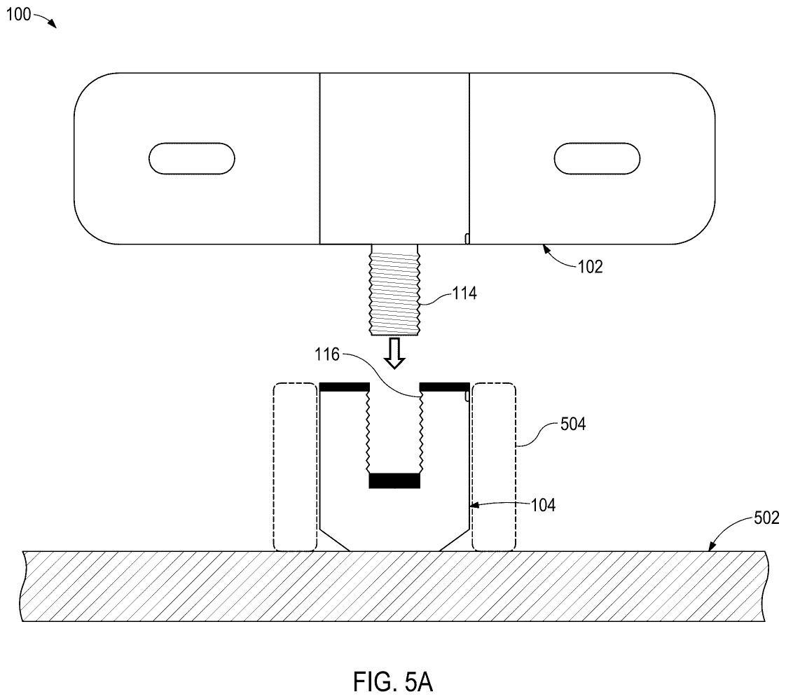

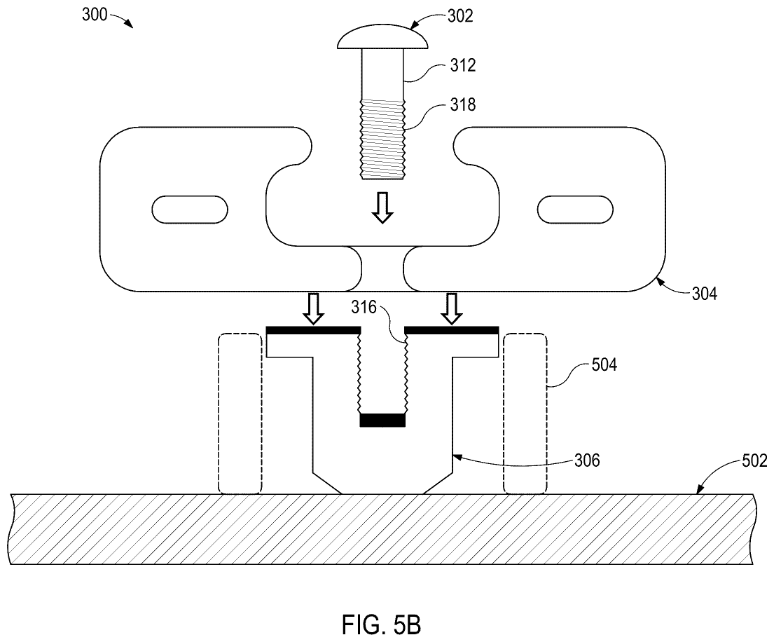

FIGS. 5A and 5B are exploded side views of the dual component welded anchor systems 100 and 300 of FIGS. 1 and 3, respectively, during example installation, according to one or more embodiments of the present disclosure. As illustrated, each system 100, 300 may be configured to be attached to a flat surface or substrate of a vessel wall 502. The vessel wall 502 may pertain to a variety of vessels configured to be lined with a refractory liner or material. Example vessels include, but are not limited to, a process vessel, a reactor (e.g., a fluidized catalytic reactor), a conduit, a furnace, a regenerator, a stack, high corrosive chemical processing equipment, or any combination thereof.

In FIG. 5A, a ceramic ferrule 504 (shown in dashed lines) is used to surround the stud base 104 as the stud base 104 is being welded to the vessel wall 502. The ceramic ferrule 504 may shroud the contact point or weld location from dust, dirt, or debris, to provide a higher quality weld. Following the welding of the stud base 104 to the vessel wall 502, the anchor head 102 may be attached to the stud base 104, therefore securing the anchor head 102 to the vessel wall 502. In the illustrated embodiment, for instance, the threaded stem 114 may be received within the threaded hole 116 to facilitate the attachment.

In FIG. 5B, similarly, the ceramic ferrule 504 is used to surround the stud base 306 during welding to shroud the contact point or weld location and thereby provide a higher quality weld between the stud base 306 and the vessel wall 502. The anchor head 304 may then be aligned with the welded stud base 306, and the fastener 302 may be inserted through the anchor head 304 and into the threaded hole 316 of the stud base 306. The stem 312 of the fastener 302 may threadably engage with the threaded hole 316 via the threads 318, such that the fastener 302, the anchor head 304, and the welded stud base 306 may be secured to the vessel wall 502.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

Embodiment 1. An anchor system, comprising: an anchor head made of a non-metallic material and including: a main body; a plurality of legs extending radially outward from the main body; and a stem extending from the main body; and a stud base made of a metallic material and defining a hole sized to receive the stem.

Embodiment 2. The anchor system of Embodiment 1, wherein non-metallic material is selected from the group consisting of a ceramic, neoprene, a silicone material, a polymer material, an epoxy, a concrete material, and any combination thereof.

Embodiment 3. The anchor system of any of Embodiments 1-2, wherein the metallic material is selected from the group consisting of carbon steel and a steel alloy.

Embodiment 4. The anchor system of any of Embodiments 1-3, wherein at least one of the plurality of legs comprises a plate-like structure, and wherein an aperture is defined in the at least one of the plurality of legs to enable flow of a refractory material through the plate-like structure.

Embodiment 5. The anchor system of any of Embodiments 1-4, wherein the stem extends from the main body orthogonal to a direction that the plurality of legs extend from the main body.

Embodiment 6. The anchor system of any of Embodiments 1-5, wherein the stem is threaded into the hole.

Embodiment 7. The anchor system of any of Embodiments 1-6, further comprising one or more alignment indicators provided on one or both of the anchor head and the stud base and providing a visual indication that the stem is properly received within the hole.

Embodiment 8. The anchor system of any of Embodiments 1-7, wherein the one or more alignment indicators are selected from the group consisting of indentions, raised features, stickers, markings, and any combination thereof.

Embodiment 9. The anchor system of any of Embodiments 1-8, further comprising one or more body gaskets interposing opposing portions of the anchor head and the stud base.

Embodiment 10. The anchor system of any of Embodiments 1-9, further comprising a stud gasket arranged at a bottom of the hole and interposing a distal end of the stem and the bottom of the hole.

Embodiment 11. The anchor system of any of Embodiments 1-10, wherein the plurality of legs comprise three legs equidistantly spaced from each other.

Embodiment 12. The anchor system of any of Embodiments 1-11, wherein the plurality of legs comprise two legs extending from the main body on angularly opposite sides of the main body, and wherein each leg includes: a first extension extending from the main body; and a second extension extending from the first extension at an angle offset from the first extension.

Embodiment 13. A method of mounting an anchor system to a vessel wall, the method comprising: locating a distal end of a stud base against the vessel wall, the stud base being made of a metallic material and defining a hole; welding the stud base to the vessel wall; and attaching an anchor head made of a non-metallic material to the stud base, the anchor head including a main body, and a plurality of legs extending radially outward from the main body.

Embodiment 14. The method of Embodiment 13, wherein the anchor head further includes a stem extending from the main body, and wherein attaching the anchor head to the stud base comprises threading the stem into the hole.

Embodiment 15. The method of any of Embodiments 13-14, wherein a central aperture is defined in the main body, and system further includes a fastener providing an enlarged head and a stem extending from the enlarged head, and wherein attaching the anchor head to the stud base comprises: extending the stem through the central aperture; and receiving the stem in the hole.

Embodiment 16. The method of any of Embodiments 13-15, wherein welding the stud base to the vessel wall further comprises: positioning a ceramic ferrule around the stud base; and shrouding a contact point between the stud base and the vessel wall with the ceramic ferrule.

Embodiment 17. An anchor system, comprising: an anchor head made of a non-metallic material and including a main body that defines a central aperture, and a plurality of legs extending radially outward from the main body; a fastener comprising an enlarged head and a stem; and a stud base made of a metallic material and defining a hole sized to receive the stem of the fastener, wherein the anchor head is secured to the stud base by extending the stem through the central aperture and receiving the stem in the hole.

Embodiment 18. The anchor system of Embodiment 17, wherein the stud base further defines a shoulder extending radially outward from an upper section of the stud base.

Embodiment 19. The anchor system of any of Embodiments 17-18, wherein the stem is threaded into the hole and threading the fastener to the stud base forms an interference fit with the anchor head.

Embodiment 20. The anchor system of any of Embodiments 17-19, wherein at least one of the plurality of legs comprises a plate-like structure, and wherein an aperture is defined in the at least one of the plurality of legs to enable flow of a refractory material through the plate-like structure.

To facilitate a better understanding of the embodiments of the present invention, the following examples of preferred or representative embodiments are given. In no way should the following examples be read to limit, or to define, the scope of the invention.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. An anchor system, comprising:
an anchor head made of a non-metallic material and including:
a main body;
a plurality of legs extending radially outward from the main body; and
a stem extending from the main body; and
a stud base made of a metallic material and defining a hole sized to receive the stem.

2. The anchor system of claim 1, wherein non-metallic material is selected from the group consisting of a ceramic, neoprene, a silicone material, a polymer material, an epoxy, a concrete material, and any combination thereof.

3. The anchor system of claim 1, wherein the metallic material is selected from the group consisting of carbon steel and a steel alloy.

4. The anchor system of claim 1, wherein at least one of the plurality of legs comprises a plate-like structure, and wherein an aperture is defined in the at least one of the plurality of legs to enable flow of a refractory material through the plate-like structure.

5. The anchor system of claim 1, wherein the stem extends from the main body orthogonal to a direction that the plurality of legs extend from the main body.

6. The anchor system of claim 1, wherein the stem is threaded into the hole.

7. The anchor system of claim 1, further comprising one or more alignment indicators provided on one or both of the anchor head and the stud base and providing a visual indication that the stem is properly received within the hole.

8. The anchor system of claim 9, wherein the one or more alignment indicators are selected from the group consisting of indentions, raised features, stickers, markings, and any combination thereof.

9. The anchor system of claim 1, further comprising one or more body gaskets interposing opposing portions of the anchor head and the stud base.

10. The anchor system of claim 1, further comprising a stud gasket arranged at a bottom of the hole and interposing a distal end of the stem and the bottom of the hole.

11. The anchor system of claim 1, wherein the plurality of legs comprise three legs equidistantly spaced from each other.

12. The anchor system of claim 1, wherein the plurality of legs comprise two legs extending from the main body on angularly opposite sides of the main body, and wherein each leg includes:
a first extension extending from the main body; and
a second extension extending from the first extension at an angle offset from the first extension.

13. A method of mounting an anchor system to a vessel wall, the method comprising:
locating a distal end of a stud base against the vessel wall, the stud base being made of a metallic material and defining a hole;
welding the stud base to the vessel wall; and
attaching an anchor head made of a non-metallic material to the stud base, the anchor head including a main body, and a plurality of legs extending radially outward from the main body.

14. The method of claim 13, wherein the anchor head further includes a stem extending from the main body, and wherein attaching the anchor head to the stud base comprises threading the stem into the hole.

15. The method of claim 13, wherein a central aperture is defined in the main body, and system further includes a fastener providing an enlarged head and a stem extending from the enlarged head, and wherein attaching the anchor head to the stud base comprises:
extending the stem through the central aperture; and
receiving the stem in the hole.

16. The method of claim 13, wherein welding the stud base to the vessel wall further comprises:
positioning a ceramic ferrule around the stud base; and
shrouding a contact point between the stud base and the vessel wall with the ceramic ferrule.

17. An anchor system, comprising:
an anchor head made of a non-metallic material and including a main body that defines a central aperture, and a plurality of legs extending radially outward from the main body;
a fastener comprising an enlarged head and a stem; and
a stud base made of a metallic material and defining a hole sized to receive the stem of the fastener,
wherein the anchor head is secured to the stud base by extending the stem through the central aperture and receiving the stem in the hole.

18. The anchor system of claim 17, wherein the stud base further defines a shoulder extending radially outward from an upper section of the stud base.

19. The anchor system of claim 17, wherein the stem is threaded into the hole and threading the fastener to the stud base forms an interference fit with the anchor head.

20. The anchor system of claim 17, wherein at least one of the plurality of legs comprises a plate-like structure, and wherein an aperture is defined in the at least one of the plurality of legs to enable flow of a refractory material through the plate-like structure.
